(19) United States
(12) Patent Application Publication
(10) Pub. No.: US 2012/0006180 A1
(43) Pub. Date: Jan. 12, 2012

(54) Sound deadening tool and sound deadening musical performance tool

(76) Inventor: Kota Hamanaga, Iwata-shi (JP)

(21) Appl. No.: 12/932,653

(22) Filed: Mar. 2, 2011

(30) Foreign Application Priority Data
Jul. 8, 2010 (JP) 2010-155422

(51) Int. Cl. G10D 9/00

(52) U.S. Cl. 84/453

(57) ABSTRACT

A sound deadening tool and a sound deadening musical performance tool have a high sound deadening effect on stringed instruments while various senses of discomfort during a musical performance, such as a musical pitch, expressive power, and a touch feeling are suppressed to a minimum level, and the sound deadening tool can easily and securely be used and attached. A vibration suppressor 10 of the sound deadening tool includes a pair of metallic weights 11 and 12 that is fixed while side faces of a saddle are sandwiched therebetween, and the pair of metallic weights 11 and 12 have a substantially identical mass.

### BACKGROUND OF THE INVENTION

1. Field of the Invention

The present invention relates to a sound deadening tool and a sound deadening musical performance tool, which can suppress a sound volume of stringed instruments having a sound box such as a guitar, a violin, and a mandolin, without making them less comfortable to play, and which are also capable of being easily and securely used and attached.

2. Description of the Related Art

Conventionally, a detachable bridge silencer is proposed as a sound deadening tool that suppresses the sound volume of the stringed instruments (see Japanese Patent Publication Laid-Open No. 2006-285078). A silencer in which a string is sandwiched between urethanes or adhesive tapes is commercially available. A silencer, in which a special sheet is attached to a soundboard of the stringed instrument to suppress a vibration of the soundboard and a sound deadening effect is obtained without affecting a feeling and a musical pitch of the string, is also proposed. There is a musical instrument dedicated to training, which does not have the soundboard and the sound box (see Japanese Patent Publication Laid-Open No. 2005-62783).

In the conventional bridge silencer that is detachably attached to the stringed instrument, unfortunately the sound volume cannot be suppressed sufficiently, and it is difficult to fix the bridge silencer easily and securely. Further, the bridge silencer may become an obstacle of musical performance or the bridge silencer may easily drop off from the bridge.

In the silencer in which the string is sandwiched between the urethanes or adhesive tapes, or the silencer in which the special sheet is attached to the soundboard of the stringed instrument and the vibration of the soundboard is suppressed to obtain the sound deadening effect, the stable vibration suppression effect is not obtained, and the silence adversely affects the natural vibration of the string. Therefore, a player cannot make musical performance with a usual touch.

The musical instrument dedicated to the training, which does not have the soundboard and the sound box is completely different from the musical instrument that the player usually plays. Therefore, although the sound deadening effect is obtained, unfortunately an actual training effect is insufficiently obtained due to a difference in the touch.

### SUMMARY OF THE INVENTION

In view of the foregoing, an object of the invention is to provide a sound deadening tool and a sound deadening musical performance tool, which have a high sound deadening effect on stringed instruments while various senses of discomfort during a musical performance regarding a musical pitch, expressive power, and a touch and so on are suppressed to a minimum level, and the sound deadening tool can easily and securely be used and attached.

In order to solve the problems and to achieve the object, the invention is configured as follows.

In accordance with a first aspect of the invention, a sound deadening tool at least includes a vibration suppressor that is mounted on a saddle of a stringed instrument including a sound box, wherein the vibration suppressor includes a pair of metallic weights that is fixed while side faces of the saddle are sandwiched therebetween, the pair of metallic weights having a substantially identical mass; the pair of metallic weights is fixed by a pair of tightening screws; and the pair of metallic weights includes recesses that are not in contact with a string attached to the saddle.

In accordance with a second aspect of the invention, a sound deadening tool at least includes: a vibration suppressor that is mounted on a saddle of a stringed instrument including a sound box; and a plate-like antivibration member that is detachably attached to the sound box, wherein the vibration suppressor includes a pair of metallic weights that is fixed while side faces of the saddle are sandwiched therebetween, the pair of metallic weights having a substantially identical mass; the pair of metallic weights is fixed by a pair of tightening screws; the pair of metallic weights includes recesses that are not in contact with a string attached to the saddle; the plate-like antivibration member includes a sheet attaching recess; a suction sheet adheres to the sheet attaching recess by a double-sided adhesive tape; and the plate-like antivibration member is detachably attached to the sound box by the suction sheet.

In accordance with a third aspect of the invention, a sound deadening musical performance tool includes an electronic module that is disposed at the back of the saddle of the stringed instrument including the sound box and at a position in an opposite direction to a neck, the electronic module enabling a player to listen to sound-deadened musical performance with a usual sound volume through an earphone in an upper surface of the detachably-attached plate-like antivibration member in accordance with the second aspect.

In accordance with the first aspect of the invention, the vibration suppressor includes a pair of metallic weights that is fixed while side faces of the saddle are sandwiched therebetween, the pair of metallic weights has a substantially identical mass, the pair of metallic weights is fixed by the pair of tightening screws, and the pair of metallic weights includes recesses that are not in contact with the string attached to the saddle. Therefore, the vibration can securely be suppressed. The pair of metallic weights is fixed by the pair of tightening screws, and the pair of metallic weights can easily and securely be mounted on the stringed instrument.

In accordance with the second aspect of the invention, the sound deadening tool includes the vibration suppressor and the plate-like antivibration member that is detachably attached to the sound box, the plate-like antivibration member includes the sheet attaching recess, and the suction sheet adheres to the sheet attaching recess by the double-sided adhesive tape, so that the sound deadening tool can be detachably attached to the sound box by the suction sheet. The outer periphery of the suction sheet is protected by the plate-like antivibration member, so that the sound deadening tool can be used for a long time.

In accordance with the third aspect of the invention, the electronic module is disposed at the back of the saddle, at the position in a direction opposite to a neck, and in the upper surface of the plate-like antivibration member that is detachably attached in a direction opposite to the neck. Therefore, the player can listen to the sound-deadened musical performance at the usual sound volume through the earphone.

### BRIEF DESCRIPTION OF THE DRAWINGS

FIG. 1 is a plan view illustrating a vibration suppressor of a sound deadening tool according to a first embodiment of the invention;

FIG. 2 is a side view of the vibration suppressor;

FIG. 3 is a bottom view of the vibration suppressor;

FIG. 4 is a side view of a metallic weight of the vibration suppressor;

FIG. 5 is a side view of the metallic weight of the vibration suppressor;

FIG. 6 is a plan view of a stringed instrument on which the sound deadening tool is mounted;

FIG. 7 is a plan view of a state in which the vibration suppressor is mounted on the stringed instrument;

FIG. 8 is a sectional view taken on a line A-A of FIG. 7;

FIG. 9 is a sectional view taken on a line B-B of FIG. 7;

FIG. 10 is a view illustrating a plate-like antivibration member of a sound deadening tool according to a second embodiment of the invention;

FIG. 11 is a view illustrating another plate-like antivibration member;

FIG. 12 is a view illustrating another plate-like antivibration member; and

FIG. 13 is a view illustrating a sound deadening musical performance tool according to a third embodiment of the invention.

### DETAILED DESCRIPTION OF THE INVENTION

A sound deadening tool and a sound deadening musical performance tool according to embodiments of the invention will be described below. The embodiments are described only by way of example, and the invention is not limited to the embodiment.

### First Embodiment

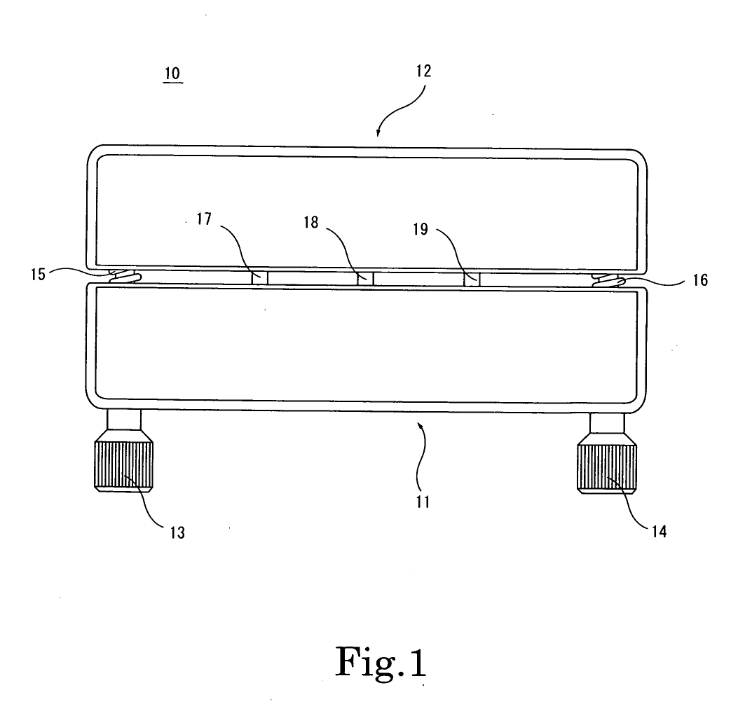

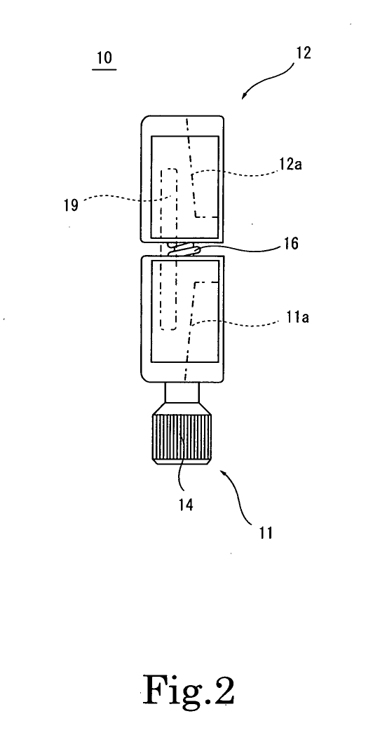

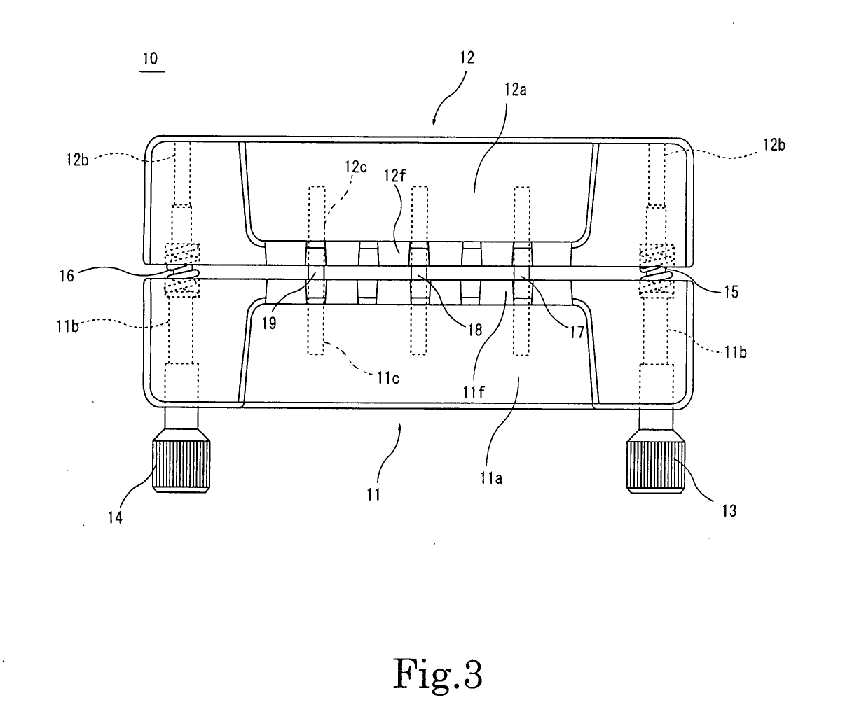

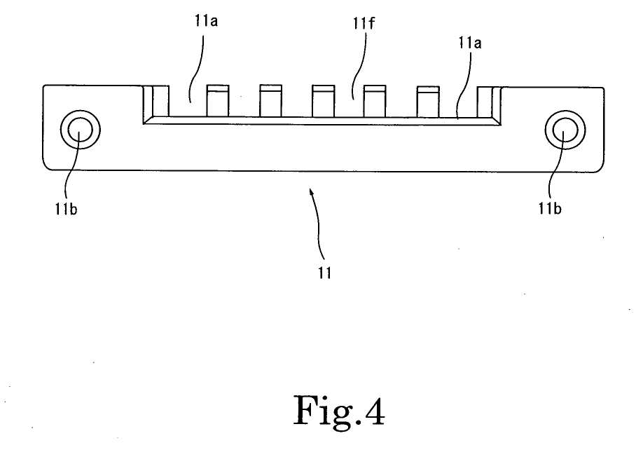

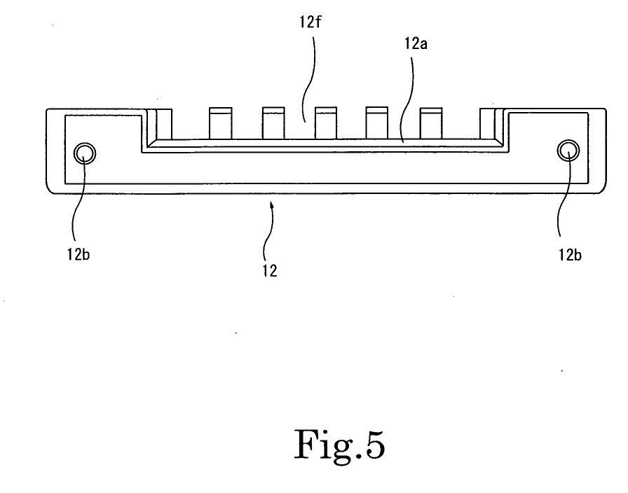

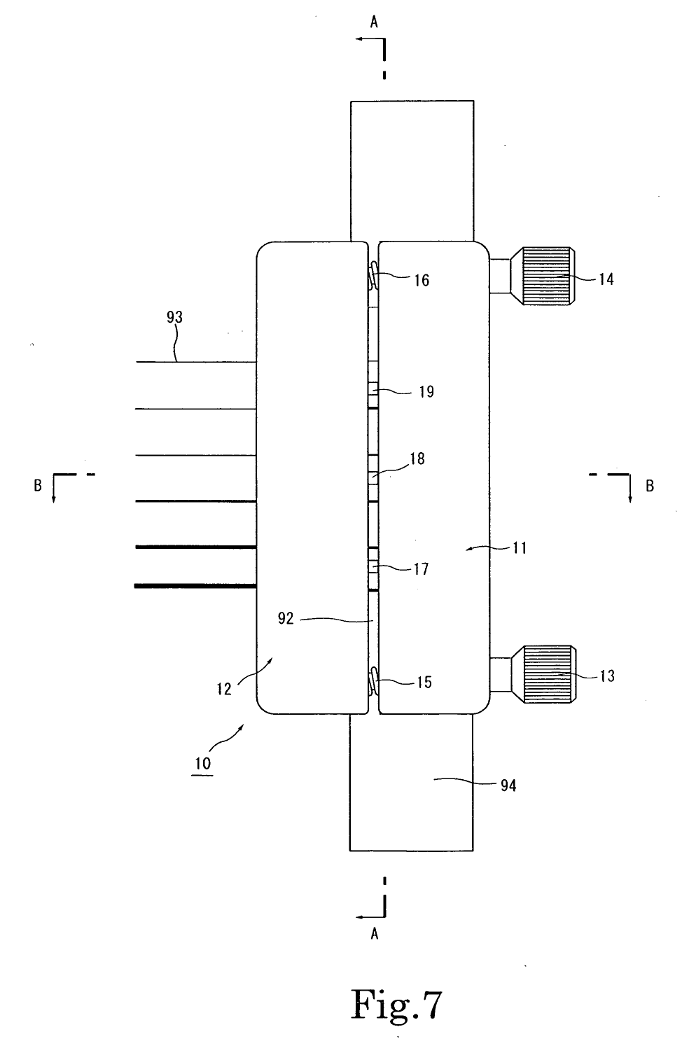

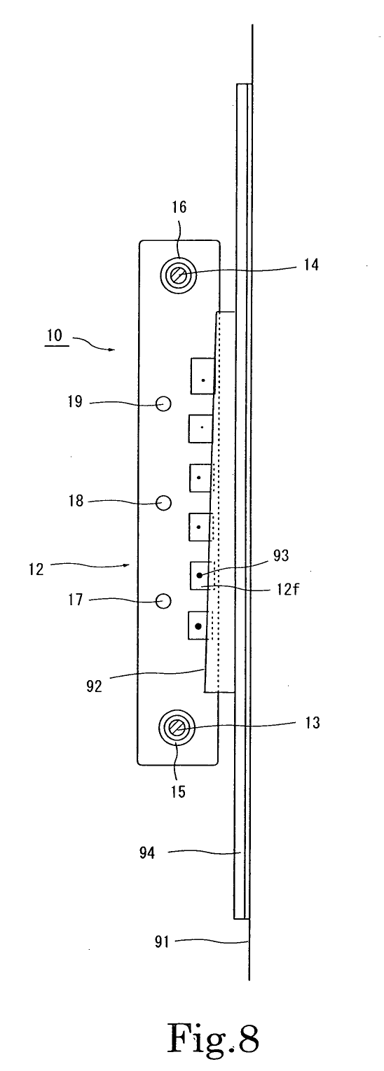

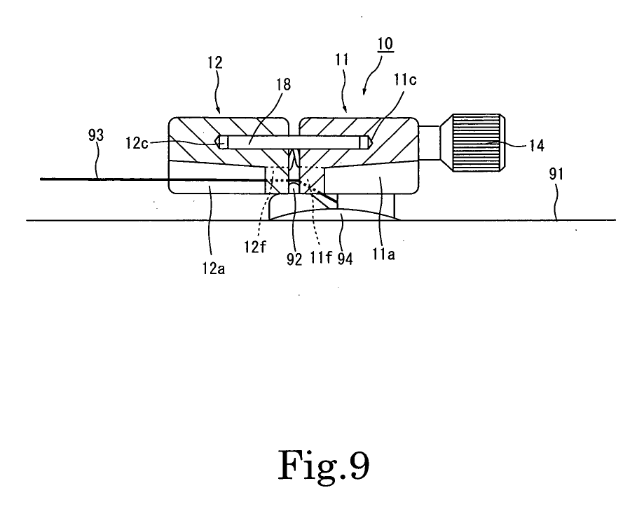

A sound deadening tool according to a first embodiment of the invention will be described with reference to FIGS. 1 to 9. The sound deadening tool of the first embodiment includes a vibration suppressor 10 that is mounted on a saddle provided on a sound box of a stringed instrument. In the embodiment, a classical guitar is used as the stringed instrument. However, the invention can also be applied to an acoustic guitar. Additionally, the invention can be applied not only to the guitar but also to stringed instruments having a sound box, such as a violin and a mandolin.

The vibration suppressor 10 includes a pair of metallic weights 11 and 12, a pair of tightening screws 13 and 14, a pair of springs 15 and 16, and three coupling pins 17 to 19. The pair of metallic weights 11 and 12 has a substantially identical mass. Preferably, each of the pair of metallic weights 11 and 12 has a total weight of 200 g or more. The pair of metallic weights 11 and 12 is made of stainless steel, steel, copper, and the like. In the pair of metallic weights 11 and 12, recesses 11a and 12a are formed on back sides, while string guide grooves 11f and 12f are formed at predetermined intervals in communication with the recesses 11a and 12a, and strings are located in the string guide grooves 11f and 12f. The pair of metallic weights 11 and 12 are not in contact with the strings while the saddle is sandwiched between the pair of metallic weights 11 and 12. The pair metallic weights 11 and 12 has a complicated shape, in which the recesses 11a and 12a are formed on the back sides of the pair of metallic weights 11 and 12 and the string guide grooves 11f and 12f are formed at predetermined intervals in communication with the recesses 11a and 12a. Although the pair of metallic weights 11 and 12 become expensive by cutting or the like, the pair of metallic weights 11 and 12 can be produced at low cost by a method such as lost wax and metal sintering.

On the other hand, mounting holes 11b are made on both sides of the metallic weight 11, and mounting screw holes 12b are formed on both sides of the metallic weight 12. In the pair of metallic weights 11 and 12, each three of coupling pin insertion holes 11c and 12c are made on each of the surfaces that face each other as mounted.

In mounting the pair of metallic weights 11 and 12, the pair of springs 15 and 16 are disposed in positions of the mounting holes 11b and mounting screw holes 12b between the surfaces that face each other while the pair of metallic weights 11 and 12 are mounted, the three coupling pins 17 to 19 are inserted in the coupling pin insertion holes 11c and 12c to connect each, and the pair of metallic weights 11 and 12 are tentatively screwed in the mounting screw holes 12b from the mounting holes 11b by the pair of tightening screws 13 and 14.

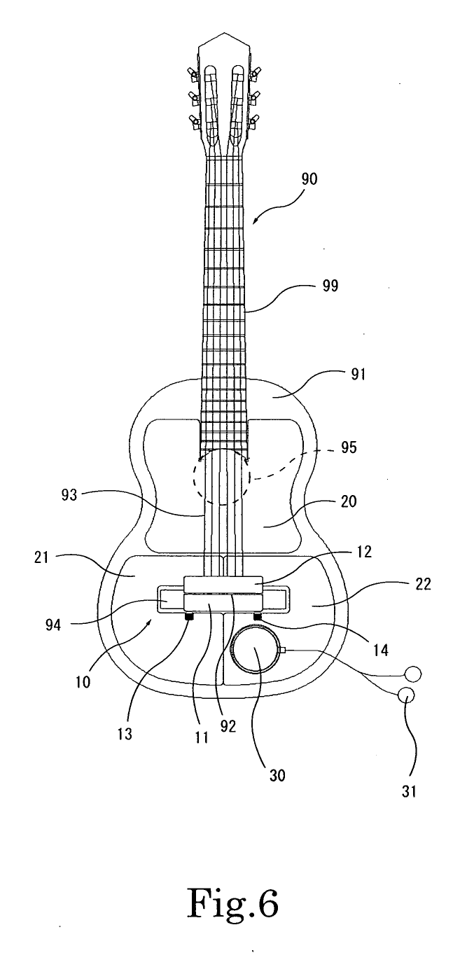

As illustrated in FIGS. 6 to 9, the pair of metallic weights 11 and 12 in the tentatively screwed state are inserted so as to place the pair of metallic weights 11 and 12 on both side faces of a saddle 92 provided on a sound box 91 of a stringed instrument 90, sandwiching the saddle 92, and the pair of tightening screws 13 and 14 are rigidly screwed in the mounting screw hole 12b while the pair of metallic weights 11 and 12 are not in contact with the string 93. The saddle 92 is provided in a bridge 94.

Thus, in the vibration suppressor 10, the pair of metallic weights 11 and 12 are coupled by the three coupling pins 17 to 19 and fixed by the pair of tightening screws 13 and 14, so that the pair of metallic weights 11 and 12 can easily and securely be mounted on the stringed instrument 90. In the structure of the vibration suppressor 10, the pair of metallic weights 11 and 12 having the substantially identical mass are disposed on the side faces of the saddle 92, and the saddle 92 is sandwiched between the pair of metallic weights 11 and 12. Therefore, the pair of metallic weights 11 and 12 facing each other do not easily drop off, because the pair of metallic weights 11 and 12 are fastened to each other by the pair of tightening screws 13 and 14 and rigidly fixed to the side faces of the saddle 92.

The pair of metallic weights 11 and 12 have the substantially identical mass, the pair of metallic weights 11 and 12 are fixed while the side faces of the saddle 92 are sandwiched therebetween, and the pair of metallic weights 11 and 12 are mounted on the saddle 92, whereby a vibration transmitted to the sound box is attenuated to reduce a sound volume. Because the pair of metallic weights 11 and 12 having the substantially identical mass are disposed on both the sides of the saddle 92, a weight balance is established in the saddle 92, a load is uniformly applied to the saddle 92, and a stable effect is obtained in vibration suppression of the sound box 91. For example, when the pair of metallic weights 11 and 12 have different weights, the pair of metallic weights 11 and 12 is inclined toward one side of the saddle 92. On the other hand, when the pair of metallic weights 11 and 12 has the substantially identical weight, the pair of metallic weights 11 and 12 is stably placed on the bridge 94, so that the pair of metallic weights 11 and 12 can easily be mounted on the saddle 92 by the pair of tightening screws 13 and 14.

In the structure of the vibration suppressor 10, the pair of metallic weights 11 and 12 includes the recesses 11a and 12a that are not in contact with the string 93 attached to the saddle 92, and the pair of metallic weights 11 and 12 is not in contact with the string while the strings are located in the string guide grooves 11f and 12f. The natural vibration of the string 93 is not affected by the pair of metallic weights 11 and 12, a player can play the stringed instrument 90 with the touch feeling as usual, harmonics performance can be played, the sense of discomfort during a musical performance is suppressed to the minimum level, and a high sound deadening effect is obtained without affecting a musical pitch and expressive power of the stringed instrument 90.

### Second Embodiment

A sound deadening tool according to a second embodiment of the invention will be described below with reference to FIG. 6 and FIGS. 10 to 12. The sound deadening tool of the second embodiment includes the vibration suppressor 10 that is mounted on the saddle 92 provided in the sound box 91 of the stringed instrument 90 and plate-like antivibration members 20 to 22 that are detachably attached to the sound box 91. Because the vibration suppressor 10 is similar to that of the sound deadening tool of the first embodiment, the description is omitted.

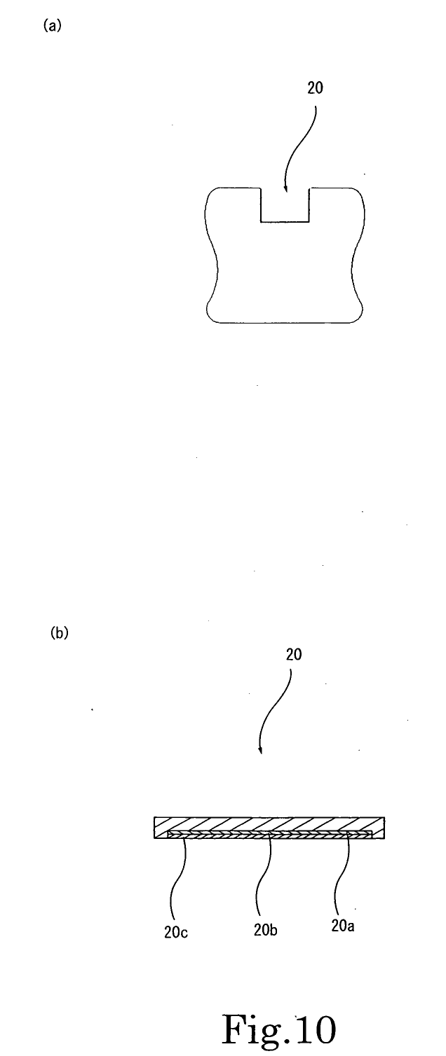

As illustrated in FIG. 10, the plate-like antivibration member 20 includes a sheet attaching recess 20a, a suction sheet 20c adheres to the sheet attaching recess 20a by a double-sided adhesive tape 20b, and the plate-like antivibration member 20 is detachably attached to the sound box 91 by the suction sheet 20c.

As illustrated in FIG. 6, the plate-like antivibration member 20 is a cover that closes a sound hole 95, the plate-like antivibration member 20 is formed by a rubber plate having a thickness of about 2 mm to 3 mm, and the sound hole 95 is closed by the plate-like antivibration member 20 to reduce the sound volume. An elastomer having a physical property close to that of rubber is also included in the rubber plate, an antivibration effect is increased with increasing specific gravity, and metallic powers can be mixed in the rubber plate in order to increase the specific gravity. A surface of the suction sheet 20c has a suction structure. When the suction sheet 20c is pressed, the surface of the suction structure becomes a negative pressure to exert the suction property. The suction sheet 20c can repeatedly adhere to or be peeled off from the plate-like antivibration member 20.

In the plate-like antivibration member 20, the suction sheet 20c adheres to the sheet attaching recess 20a by the double-sided adhesive tape 20a, the plate-like antivibration member 20 is detachably attached to the sound box 91 by the suction sheet 20c, and an outer periphery of the suction sheet 20c is surrounded and protected by the plate-like antivibration member 20, so that the plate-like antivibration member 20 can be used for a long time.

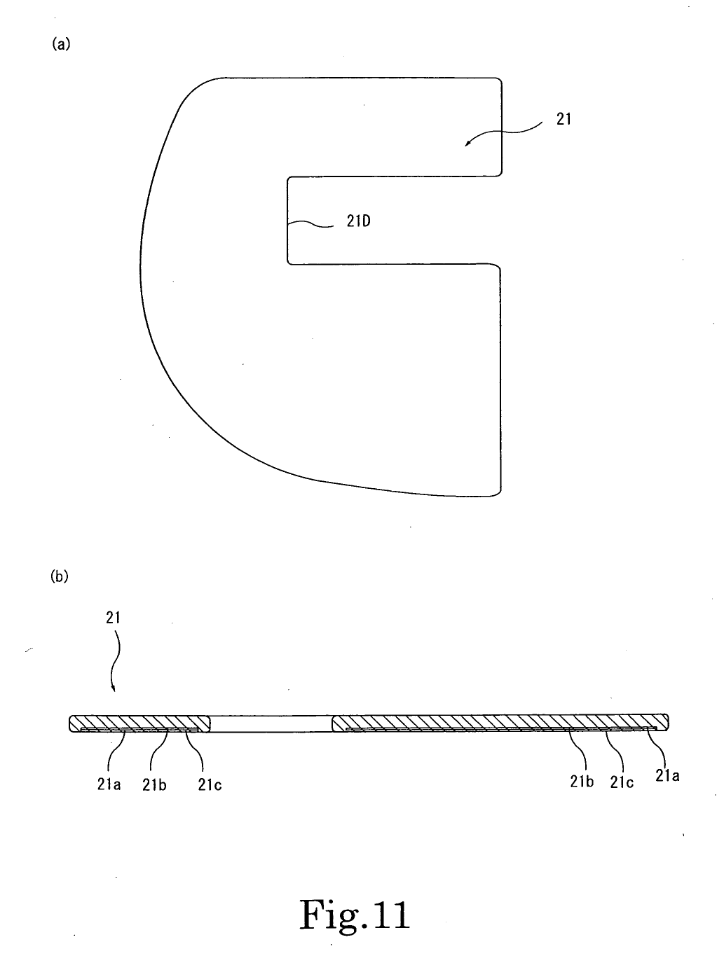

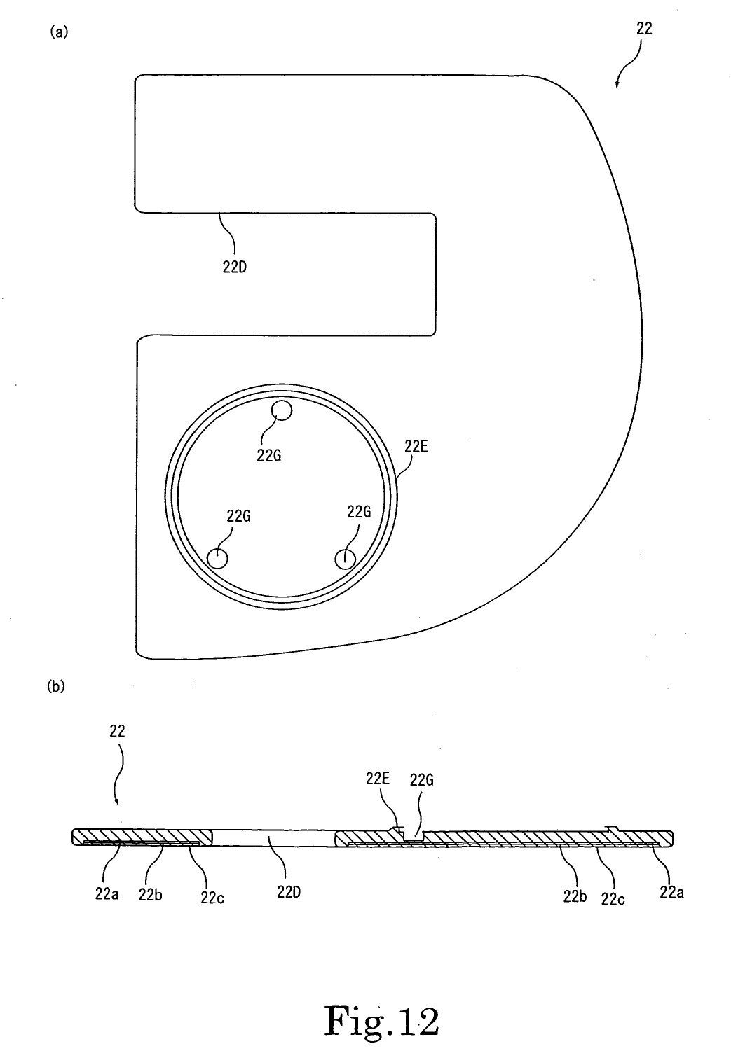

As illustrated in FIG. 11 and FIG. 12, the plate-like antivibration members 21 and 22 include notches 21D and 22D, sheet attaching recesses 21a and 22a are formed so as to surround the bridge 94 of the sound box 9, suction sheets 21c and 22c adhere to the sheet attaching recesses 21a and 22a by double-sided adhesive tapes 21b and 22b, and the plate-like antivibration members 21 and 22 are detachably attached to the sound box 91 by the suction sheets 21c and 22c so as to surround the bridge 94.

The plate-like antivibration members 21 and 22 are formed by a rubber plate having a thickness of about 4 mm to 6 mm, and the plate-like antivibration members 21 and 22 are attached to the sound box 91 to reduce the sound volume. An elastomer having a physical property close to that of rubber is also included in the rubber plate, an antivibration effect is increased with increasing specific gravity, and metallic powers can be mixed in the rubber plate in order to increase the specific gravity. Surfaces of the suction sheets 21c and 22c have the suction structure. The suction sheets 21c and 22c can repeatedly adhere to or be peeled off from the plate-like antivibration member 20.

### Third Embodiment

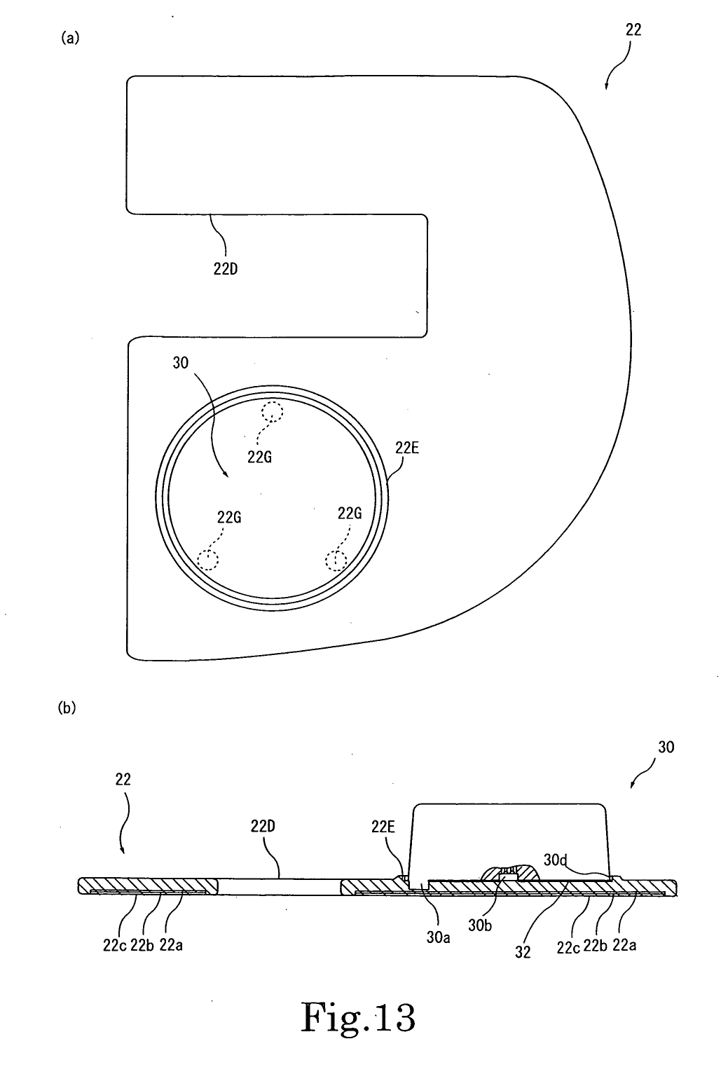

A sound deadening musical performance tool according to a third embodiment of the invention will be described below with reference to FIG. 6, FIG. 12, and FIG. 13. The sound deadening musical performance tool of the third embodiment includes an electronic module 30. The electronic module 30 is disposed at the back of the saddle 92, at a position in a direction opposite to a neck 99, and in an upper surface of the plate-like antivibration member 22. The electronic module 30 enables a player to listen to the musical performance through an earphone 31 with a usual sound volume.

The plate-like antivibration member 22 of the third embodiment is similar to that of the sound deadening tool of the second embodiment.

Three engaging projections 30a are formed in the electronic module 30. As illustrated in FIG. 13, the engaging projections 30a are fitted in electronic module mounting holes 22G of the plate-like antivibration member 22 that is detachably attached to the sound box 91, whereby preventing the electronic module 30 from rotating. Additionally, the electronic module 30 adheres to the plate-like antivibration member 22 by an electronic module fixing double-sided tape 32, so that the electronic module 30 can securely and closely be in contact with the plate-like antivibration member 22 without making a rattling noise.

The electronic module 30 is disposed at the back of the saddle 92, at the position in an opposite direction to the neck 99, and in the upper surface of the plate-like antivibration member 22. Therefore, the microphone 30b is in close contact with the upper surface of the plate-like antivibration member 22, and the microphone 30b picks up sound from the sound box to amplify the sound, so that the player can listen to the sound-deadened musical performance through the earphone 31 with the usual sound volume.

Thus, the electronic module 30 is disposed at the back of the saddle 92, at the position in the opposite direction to the neck 99, and in the upper surface of the plate-like antivibration member 22, and the sound in the electronic module 30 is picked up by the microphone 30b located in the lower portion surface of the electronic module 30. Therefore, the good sound can be collected.

Because the electronic module 30 is disposed at the back of the saddle 92 and at the position in the opposite direction to the neck 99, the electronic module 30 does not become an obstacle of the musical performance during stroke. As to the site where the electronic module 30 picks up the sound, a good tone color is obtained in the position at the back of the saddle 92 and in the direction opposite to the neck 99. Better sound quality is obtained by picking up the sound passing through the plate-like antivibration member 22 with the microphone 30b compared with the case in which the microphone 30b is brought into direct contact with the sound box 91.

The invention can be applied to the sound deadening tool and the sound deadening musical performance tool, which can suppress the sound volume of the stringed instruments having a sound box, such as the guitar, the violin, and the mandolin, without making them less comfortable to play, and which are also capable of being easily and securely used and attached. The sound deadening tool and the sound deadening musical performance tool of the invention can easily and securely be mounted on the stringed instruments, the sense of discomfort during a musical performance is suppressed to the minimum level, and the high sound deadening effect is obtained without affecting the musical pitch and expressive power of the stringed instrument.

### EXPLANATIONS OF LETTERS OR NUMERALS

10 vibration suppressor
11, 12 pair of metallic weights
11a, 12a recess
11b mounting hole
11c, 12c coupling pin insertion hole
11f, 12f string guide groove
12b mounting screw hole
13, 14 pair of tightening screws
15, 16 pair of springs
17, 18, 19 coupling pin
20, 21, 22 plate-like antivibration member
20a, 21a, 22a sheet attaching recess
20b, 21b, 22b double-sided adhesive tape
20c, 21c, 22c suction sheet
21D, 22D notch
22E electronic module mounting projection
22G electronic module mounting hole
30 electronic module
30a engaging projection
30b microphone
31 earphone
32 electronic module fixing double-sided tape
90 stringed instrument
91 sound box
92 saddle
93 string
94 bridge
95 sound hole
99 neck

What is claimed is:

1. A sound deadening tool comprising a vibration suppressor that is mounted on a saddle of a stringed instrument including a sound box,
wherein the vibration suppressor includes a pair of metallic weights that is fixed while side faces of the saddle are sandwiched therebetween, the pair of metallic weights having a substantially identical mass,
the pair of metallic weights is fixed by a pair of tightening screws, and
the pair of metallic weights includes recesses that are not in contact with a string attached to the saddle.

2. A sound deadening tool comprising:
a vibration suppressor that is mounted on a saddle of a stringed instrument including a sound box; and
a plate-like antivibration member that is detachably attached to the sound box,
wherein the vibration suppressor includes a pair of metallic weights that is fixed while side faces of the saddle are sandwiched therebetween, the pair of metallic weights having a substantially identical mass,
the pair of metallic weights is fixed by a pair of tightening screws,
the pair of metallic weights includes recesses that are not in contact with a string attached to the saddle,
the plate-like antivibration member includes a sheet attaching recess,
a suction sheet adheres to the sheet attaching recess by a double-sided adhesive tape, and
the plate-like antivibration member is detachably attached to the sound box by the suction sheet.

3. A sound deadening musical performance tool comprising an electronic module that is disposed at the back of the saddle of the stringed instrument including the sound box and at a position in an opposite direction to a neck, the electronic module enabling a player to listen to sound-deadened musical performance with a usual sound volume through an earphone in an upper surface of the detachably-attached plate-like antivibration member according to claim 2.
